(19) United States
(12) Patent Application Publication
(10) Pub. No.: US 2026/0095453 A1
(43) Pub. Date: Apr. 2, 2026

(54) UNIFIED ACCESS CONTROL MECHANISM

(71) Applicant: Dell Products L.P., Round Rock, TX (US)

(72) Inventors: SHIRA RIVKA REDLICH, Jerusalem (IL); MAXIM BALIN, Gan-Yavne (IL); ELIYAHU ROSENES, Bet Shemesh (IL)

(21) Appl. No.: 18/901,292

(22) Filed: Sep. 30, 2024

(51) Int. Cl. H04L 9/40

(52) U.S. Cl. CPC H04L 63/101; H04L 63/105; H04L 63/20

(57) ABSTRACT

Methods and systems for managing operation of a deployment are disclosed. The operation may be managed by generating a unified access control mechanism for confirming privileges of a role of a user. The unified access control mechanism may be an access control management system. The access control management system may ingest a security token from a first access control of a first software. The security token may include with first privileges of the first software. The access control management system may generate an access control management token with rewritten privileges. The rewritten privileges may include the first privileges in terms of second privileges of a second software. The access control management token may be used by the user to access a resource from the second software.

### FIELD

Embodiments disclosed herein relate generally to managing operation of a deployment. More particularly, embodiments disclosed herein relate to generating a unified access control mechanism for confirming privileges of a user for software.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show interaction diagrams illustrating operation of a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting.

Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The deployment may be managed by generating a unified access control mechanism for communicating privileges. The unified access control mechanism may be an access control management system.

The access control management system may ingest a first security token generated by a first access control of a first software. The first security token may include first privileges for a role of a user on the first software. Upon ingestion, the access control management system may generate an access control management token. The access control management token may generate the access control management token by rewriting the first privileges in terms of second privileges to generate rewritten privileges and writing the rewritten privileges on a new data structure to be the access control management token.

The access control management token may be used by the user to acquire a resource from a second software. The access control management token may be used because the access control management system may read the rewritten privileges to confirm the role of the user on the second software. The access control management token may be used in place of a second security token that is generated by an administrator for a second access control system.

In an embodiment, a method for managing operation of a deployment is disclosed. The method may include: (i) obtaining, by an access control management system and from a first access control system, a token issued by the first access control system for a user of first software associated with the first access control system and a request for use of second software, (ii) generating, by the access control management system, a management token based on the token and a mapping repository, and (iii) providing, by the access control management system, the management token to the first access control system to enable the user to use second software without requiring a second access control system for the second software to be queried for privilege of the user.

The method may further include: (i) identifying, before obtaining the token issued by the first access control system, the first software and the first access control system of the first software in the deployment, (ii) identifying the second software and the second access control system of the second software in the deployment, (iii) installing the access control management system in the deployment to serve as a central access control hub for the first access control system and for the second access control system, (iv) configuring the access control management system with the mapping repository to translate first privileges for the first software from the token issued by the first access control system into second privileges for the second software, and (v) generating a trust network by establishing a secure communication protocol between the access control management system, the first access control system and the second access control system.

The first access control system may grant access to a user, based on first privileges of a role assigned to the user, to obtain data from the first software.

The token may store the first privileges of the role assigned to the user and is used to authenticate an identity of the user by the first access control system.

The management token may store the first privileges written in terms of second privileges the second software.

The mapping repository may include definitions for the first privileges for the first software, the definitions of the second privileges for the second software, and the definitions that associate the first privileges with the second privileges and that are used to derive the second privileges from the first privileges during generation of the management token.

Generating, by the access control management system, the management token may include (i) obtaining, from the mapping repository, related definitions of the definitions that relate the first privileges of the first software to the second privileges of the second software, (ii) using the related definitions to recast the role of the user, from the token, in terms of the second privileges to generate rewritten privileges, and (iii) generating, using the rewritten privileges, a management token that comprises the role of the user, the management token storing the rewritten privileges.

The method may further include: (i) obtaining, from the first access control system, a request for the management token and the token, (ii) logging, by the access control management system, the request for the management token, (iii) generating the management token when the token is valid and the request is verified and (iv) invalidating the token when malicious activity is detected in the request.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

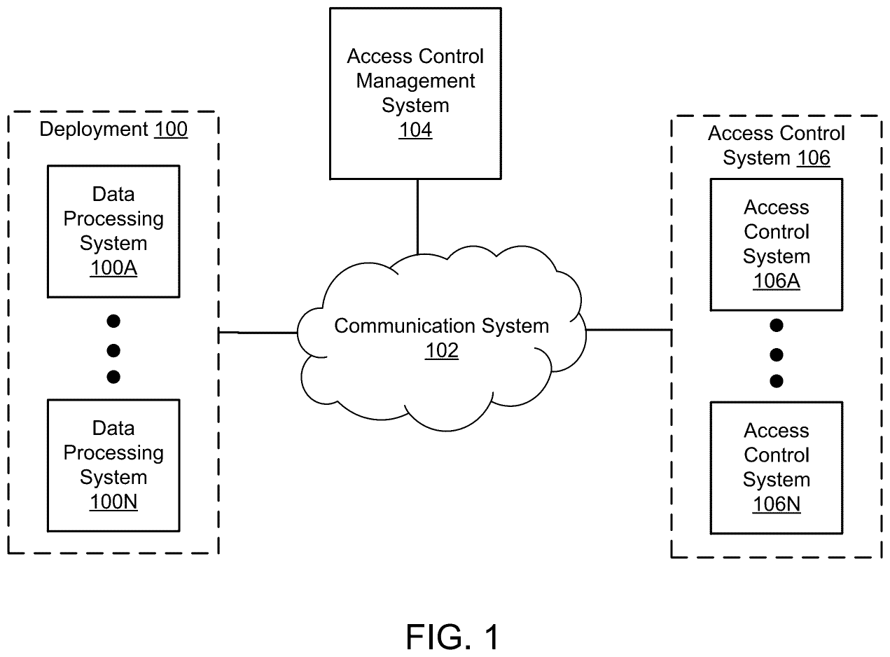

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, various software may be used. A first software of the various software may include a first access control system that includes first privileges of a user. The first privileges may be defined by an administrator of the first access control system of the first software.

For a second software, the administrator may also define second privileges for a second access control system for the user to use the second software. Generating definitions of the first privileges and/or the second privileges may include independent processes that are performed by the administrator. Because independent processes are included, at least one error may occur during generation of the definitions of the first privileges and/or the second privileges. The at least one error may include (i) over-privileging and/or under-privileging of a user, (ii) syntax errors in definitions of the first privileges and/or the second privileges, (iii) logic errors (e.g., generation of redundant privileges, generation of the privileges that include circular dependencies, etc.). As a result of the at least one error, the user with the first privileges may lack access to the first software and/or the user without the first privileges may have unauthorized access to the first software.

In general, embodiments disclosed here relate to systems and methods for managing operation of a deployment. The operation may be managed by establishing an access control management system. The access control management system may be established by integrating first access policies of a first access control system and second access policies of a second access control system. The first access policies may be used to define first privileges of a user to access a first resource from first software. Similarly, the second access policies may be used to define second privileges of the user to access a second resource from second software.

Once the first access policies and the second access policies are integrated in the access control management system, a trust network may be established between the access control management system, the first access control system, and the second access control system. The trust network may be established by instantiating, by the access control management system, a secured network connection through which the first privileges and/or the second privileges of the user may be passed.

The user may attempt to login from the first software. The user may login by inputting a username and/or password into the first software. After input of the username and/or password, the first access control system may verify the username and/or password. Once the username and/or password are verified, the first access control system may generate a security token for the user. The security token may include (i) the username, (ii) date issued, (iii) audience (e.g. the first software), (iv) expiration date and/or time, etc. The security token may be used to retrieve a first resource from the first software.

With the access control management system, the security token may be used in a request for a second resource from the second software. To obtain the second resource from the second software, the request may be sent to the first access control system. Upon receiving the request, the first access control system may attempt to read the security token for second privileges to access the second resource. However, the second privileges may not be written on the security token. As a result, the first access control system may pass the request to the access control management system.

Upon receiving the request and the security token, the access control management system may generate an access control management token. The access control management token may be generated by (i) generating a encoded data structure, such as a digital certificate, JavaScript Object Notation (JSON) object, etc. to be the access control management token, (ii) translating the first privileges from the security token in terms of the second privileges to generate rewritten privileges necessary to obtain the second resource from the second software and (iii) writing the rewritten privileges on the access control management token. In addition, on the access control management token may be written (i) the username, (ii) date issued, (iii) audience (e.g. the first software and/or the second software), (iv) expiration date and/or time, etc. Once the access control management token has been generated, the access control management system may provide the access control management token to the user.

The user may use the access control management token to make a request for the second resource using the first software. The user may use the access control management token by submitting the request to the access control management system. The access control management system may ingest the rewritten privileges from the access control management token. Using the rewritten privileges, the access control management system may determine that the user has sufficient privileges to obtain the second resource from the second software. Therefore, the access control management system may permit the second software to retrieve the second resource and provide the second resource to the first software. From the first software, the user may obtain the second resource.

To provide the above noted functionality, the system may include deployment 100, access control management system 104, and access control system 106. Each of these components is discussed below.

Deployment 100 may include any number of data processing system 100A-100N. The any number of data processing system 100A-100N may include software. The software may include at least one resource (e.g., data) that may be accessible through the any number of data processing system 100A-100N. To obtain the resource, a user may login to the software. Logging into the software may require input of at least a username and/or password. At least the username and/or password may be verified by access control system 106.

Access control system 106 may include any number of access control system 106A-106N. Access control system 106 may receive at least the username and/or password. Access control system 106 may verify the username by performing a lookup in a database and searching for the username. Once the username is found, then access control system 106 may verify the password. Access control system 106 may verify the password by hashing the password to generate a hashed password. Access control system 106 may then search the database for a stored hashed password associated with the username. Once the stored hashed password associated with the username is found, then the hashed password may be compared to the stored hashed password.

If the hashed password matches the stored hashed password, then access control system 106 may generate a security token. The security token may include (i) the username, (ii) date issued, (iii) audience (e.g. the first software), (iv) expiration data and/or time, etc. The security token may be used to verify at least one privilege to access the at least once resource. However, the security token may include the at least one privilege for the software on one data processing system of data processing system 100A-100N. For example, a first security token generated by access control system 106A may include first privileges for the user to obtain a first resource from first software on data processing system 100A. Similarly, a second security token generated by access control system 106B may include second privileges for the user to obtain a second resource from second software on data processing system 100B. For the user to obtain the first resource and/or the second resource from any number of data processing system 100A-100N, access control management system 104 may be utilized.

Access control management system 104 may permit the user to request the second resource from the first software on data processing system 100A. The user may be permitted by receiving, from the access control system 106A and by the access control management system 104, the first security token. Access control management system 104 may generate an access control management token by (i) generating a encoded data structure, such as a digital certificate, JavaScript Object Notation (JSON) object, etc. to be the access control management token, (ii) ingesting the first privileges on the first security token, (iii) translating the first privileges in terms of the second privileges to generate rewritten privileges, (iv) writing the rewritten privileges on the access control management token, and (v) providing the access control management token to the user.

The user may use the access control management token to request the second resource from the second software. The user may submit a request with the access control management token to access control management system 104. Access control management system 104 may (i) receive the access control management token, (ii) read the rewritten privileges on the access control management token, and (iii) permit, upon confirmation of the rewritten privileges, provision of the second resource by the second software from data processing system 100B to the user.

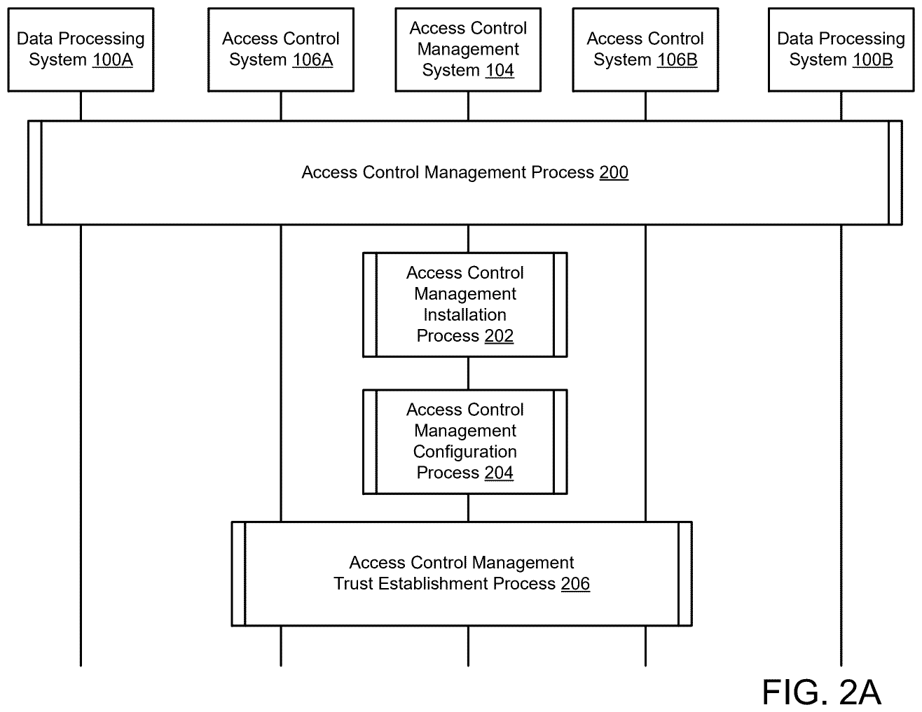

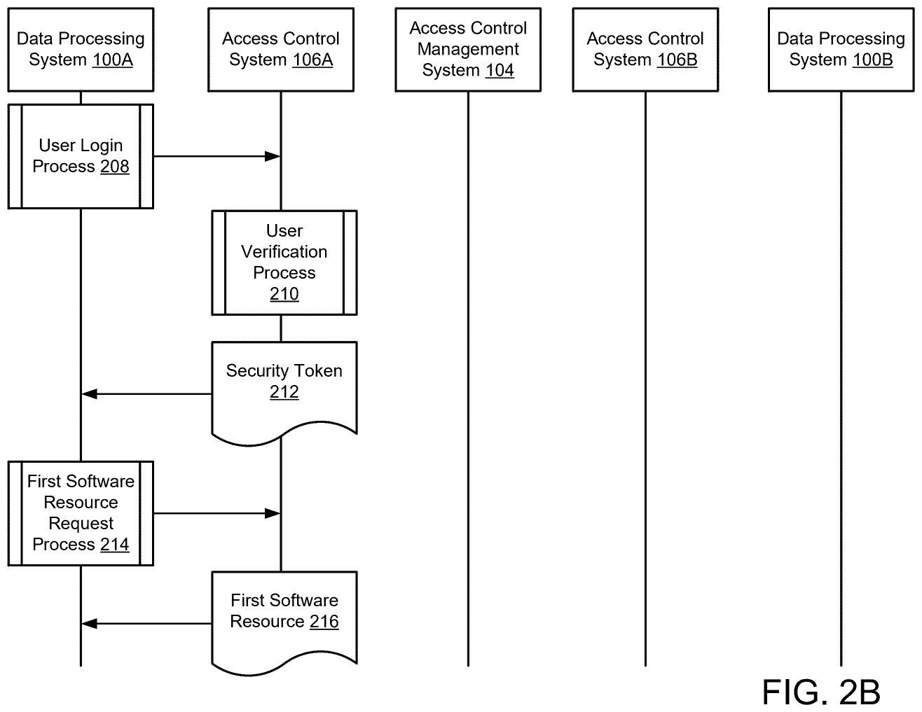

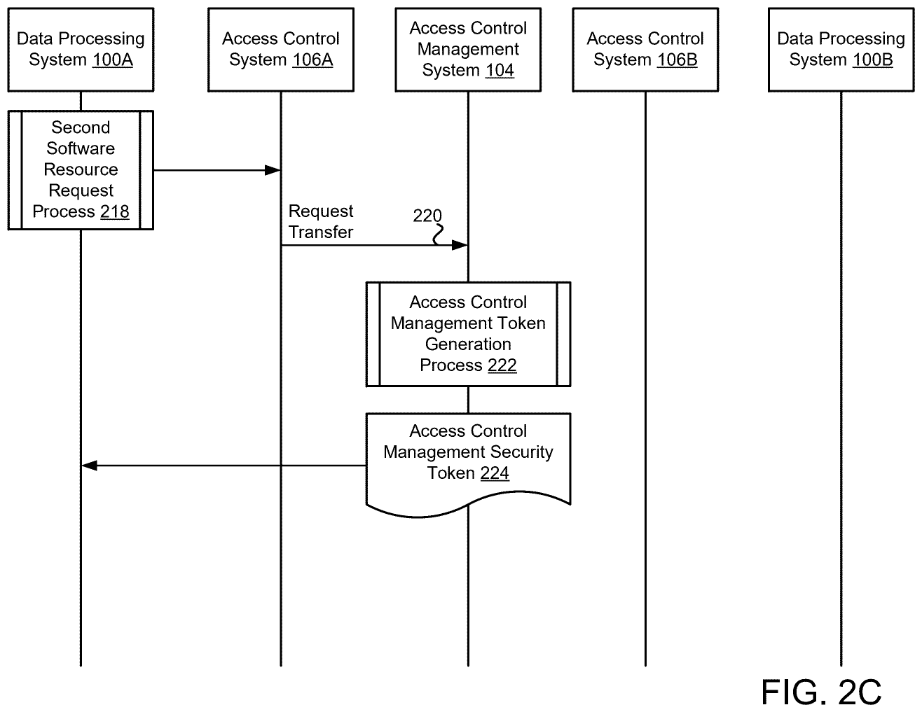

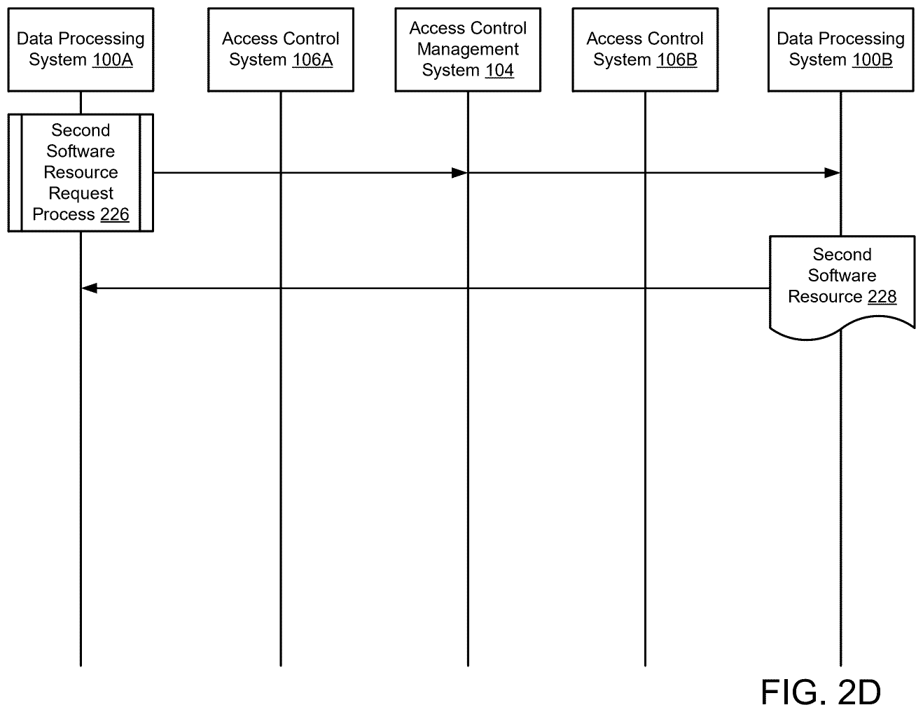

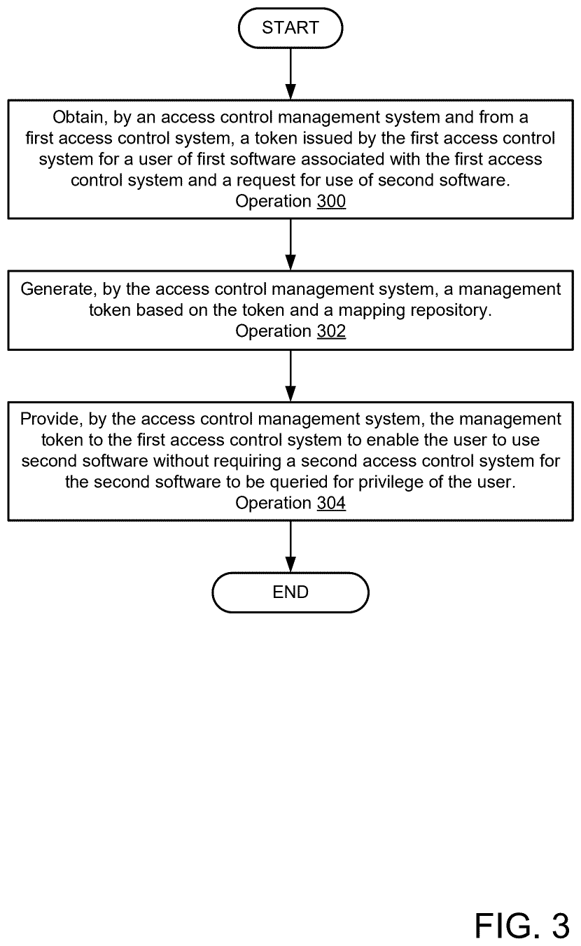

While providing their functionality, any of deployment 100, access control management system 104, and access control system 106 may perform all, or a portion, of the flows and methods shown in FIGS. 2A-3.

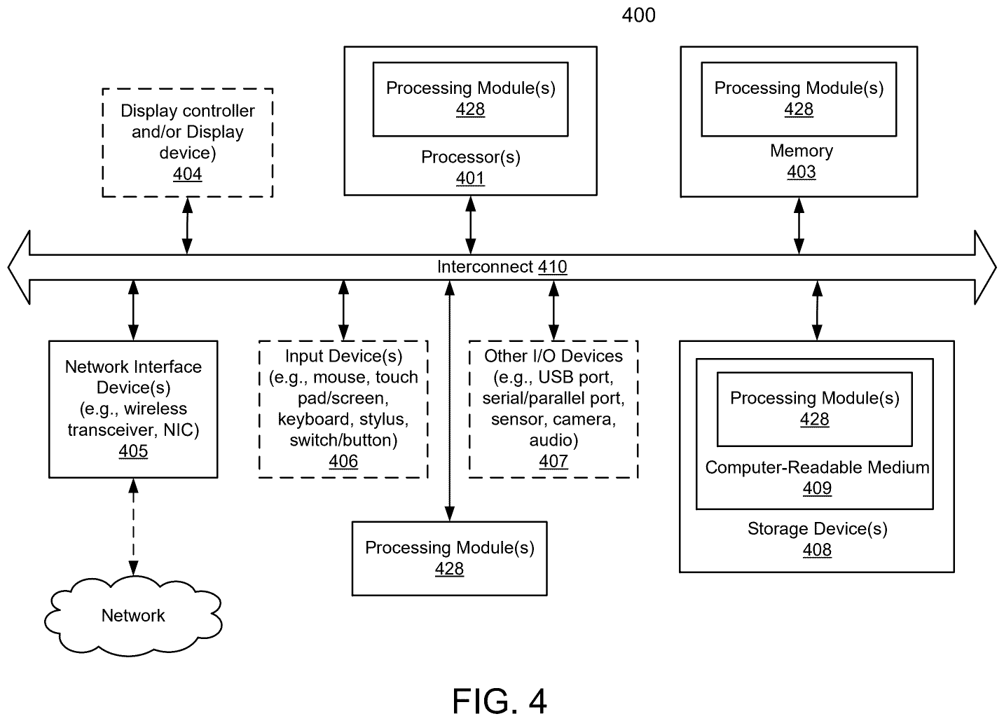

Any of (and/or components thereof) deployment 100, access control management system 104, and access control system 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2D. These interactions diagrams may illustrate how data may be obtained and used within the system of FIG. 2A-2D.

In the interaction diagrams, processes performed by and interactions between components of a system in accordance with an embodiment are shown. In the diagrams, components of the system are illustrated using a first set of shapes (e.g., 100A, 106A, etc.), located towards the top of each figure. Lines descend from these shapes. Processes performed by the components of the system are illustrated using a second set of shapes (e.g., 200, 202, etc.) superimposed over these lines. Interactions (e.g., communication, data transmissions, etc.) between the components of the system are illustrated using a third set of shapes (e.g., 220, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 220 may occur prior to the interaction following 224. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate data used in and data processing performed in establishing a trust network between an access control management system and at least one access control system.

To establish the trust network, access control management process 200 may be performed. During access control management process 200, data processing system 100A and access control system 106A may be identified. To identify data processing system 100A and/or access control system 106A, access control management system 104 may send a request for an authorization key. The authorization key may include a digital certificate, token, application programming interface (API) key, etc.

Data processing system 100A and/or access control system 106A may receive the request and respond by sending the authorization key to access control management system 104. Access control management system 104 may verify the authorization key. For example, a digital certificate may be verified by a trusted certificate authority. In another example, a token may be verified using a token validation service. The trusted certificate authority and/or the token validation service may be included in access control management system 104.

Once the authorization key is verified, data processing system 100A and/or access control system 106A may be added to a list of trusted systems for and stored by access control management system 104. Data processing system 100B and/or access control system 106B as well as other data processing systems and access control systems may be added to the list of the trusted systems in during access control management process 200 as well.

Once the data processing systems and the access control systems are added to the list of the trusted systems, access control management installation process 202 may be performed. During access control management installation process 202, software components may be installed on access control management system 104. The software components may include (i) an operating system and applications, (ii) databases, (iii) configuration files to define parameters, options, settings and/or preferences applied to the operation system, and/or the applications, etc.

Once access control management system 104 is installed, access control management configuration process 204 may be performed. During access control management configuration process 204, access control management system 104 may be integrated with data processing system 100A and data processing system 100B. Access control management system 104 may be integrated by writing settings for each data processing system. The settings may include (i) uniform resource locators (URLs) for access from and/or to an access control system, (ii) authentication tools to read a token generated by the access control system, (iii) URLs for receiving data from the access control system, (iv) at least one control to limit an allowed number of API calls from the access control system, etc.

The authentication tools may include a mapping repository, a policy repository, etc. The mapping repository may include definitions that allow first privileges from a first data processing system to be translated in terms of second privileges from a second data processing system. The policy repository may include at least one policy for at least access control system that is used to determine at least one privilege for at least one data processing system. For example, a first policy may be used by the first access control system to determine the first privileges for a first software.

Once access control management system 104 is configured, access control management trust establishment process 206 may be performed. During access control management trust establishment process 206, a trust network between access control management system 104 and at least one access control system (e.g., 106A, 106B, etc.) may be established. The trust network may be established by configuring the at least one access control system to communicate with access control management system 104 and enforcing the at least one policy of the at least one access control system.

The at least one access control system may communicate with access control management system 104 through exchange of transport layer security (TLS) and/or secure sockets layer (SSL) certificates. Using TLS/SSL certificates, data passed between access control management system 104 and the at least one access control system may be encrypted and secured from eavesdropping and/or tampering.

Thus, via the interaction illustrated in FIG. 2A, a system in accordance with an embodiment may establish the trust network between the access control management system and the at least one access control system. Consequently, a deployment (e.g., 100) may be more likely to be able to provide desired computer implemented services by permitting secure communication of privileges between access control systems.

Turning to FIG. 2B, a second interaction diagram in accordance with an embodiment is shown. The second interaction diagram may illustrate data used in and data processing performed in performing a request for a first resource from a first software.

To perform the request for the first resource from the first software, user login process 208 may be performed. During user login process 208, a user may login to a first software of a data processing system (e.g., 100A). The user may login to the first software by providing a username and/or password to the first software. The username and the password may be ingested by the first software.

Upon ingestion of the username and the password of the user, user validation process 210 may be performed. During user validation process 210, the username and password may be passed from the first software to a first access control system (e.g., 106A) of the first software. The first access control system may verify the username by searching for the username in a database in the first access control system. If the username is not found, then the user may not be permitted to use the first software and/or acquire the first resource from the first software.

However, if the username is found, then the password may be verified next. To verify the password, a hashed password may be generated by hashing the password. The hashed password may then be compared to a stored hashed password that is stored in the database in the first access control system. If the hashed password does not match the stored hashed password, then the user may not be permitted to use the first software and/or acquire first resource from the first software.

However, if the hashed password matches the stored hashed password, then security token 212 may be generated and may be passed to the data processing system (e.g., 100A). Security token 212 may include details such as (i) the username, (ii) first privileges assigned to the user, (iii) a token identifier, (iv) an issuer name, (v) issue date and time, (iv) expiration date and/or time, etc.

The first privileges assigned to the user may include actions that the user is allowed to perform on the first software and what resources the user is allowed to access. The first privileges may help enforce at least one access control policy and ensure that the user can only perform operations to which they are permitted. The first privileges may include (i) read access, (ii) write access, (iii) execute access, (iv) administrative access, (v) resource-specific access, etc. Administrative access may include access to controls over system settings and system resources. Resource-specific access may include access to types of resources. For example, the user with the resource-specific access may be able to acquire user records and not financial records concerning the user.

Using security token 212, first software resource request process 214 may be performed. During first software resource request process 214, the user may make a request using the first software. The user may make the request by, for example, generating source code in a script which includes a function call for acquisition of first resource and also includes security token 212 in the script. The first resource may be acquired from the first software. The script may be passed to the first access control system (e.g. 106A).

The first access control system (e.g., 106A) may receive the script and may extract the function call for the acquisition of the first resource and security token 212. The first access control system may verify the authenticity of security token 212 by verifying (i) a signature of token to ensure the signature has not been modified, (ii) an expiration date and/or time on the token to ensure the data and/or the time have not passed, (iii) an issuer of the token, which, for example, can be the first access control system (e.g., 106A), etc.

Once the authenticity of security token 212 has been verified, the first privileges of security token 212 may be ingested. The first access control system may ensure the first privileges include the function call for the acquisition of the first resource. The function call may include, for example, a read access for the first resource. Once the first privileges have been ensured to include the function call for the first resource, the first access control system (e.g., 106A) may perform the function call to acquire first software resource 216. During performance of the function call, (i) a search may be performed for the first resource in a repository of resources in the first software, (ii) the first resource may be found in the repository of the resources, (iii) the first resource may be extracted from the repository of the resources, and (iv) the first resource may be provided by permission from the first access control system (e.g., 106A) of the first software to the user on the data processing system (e.g. 100A). First software resource 216 may include data stored in files, folders that include files, database records, software, etc.

Thus, via the interaction illustrated in FIG. 2B, a system in accordance with an embodiment may perform the request for the first resource from the first software. Consequently, a deployment (e.g., 100) may be more likely to be able to provide desired computer implemented services by generating a security token, which is not only needed for acquisition of the first resource, but also needed to utilize access control management system 104 to acquire a second resource from a second software. Acquisition of the second resource may be described in at least one description of subsequent figures.

Turning to FIG. 2C, a third interaction diagram in accordance with an embodiment is shown. The third interaction diagram may illustrate data used in and data processing performed in generating an access control management security token.

To acquire the access control management security token, second software resource request process 218 may be performed. During second software resource request process 218, the user may make a second request using the first software. The user may make the second request by, for example, generating a second source code in a second script which includes a second function call for acquisition of second resource and also includes security token 212 in the second script. The second resource may be acquired from a second software. The script may be passed to the first access control system (e.g. 106A).

The first access control system (e.g., 106A) may receive the second script and may extract the function call for the acquisition of the second resource and security token 212. The first access control system (e.g., 106A) may verify the authenticity of the token by verifying (i) a signature of token to ensure the signature has not been modified, (ii) an expiration date and/or time on the token to ensure the data and/or the time have not passed, (iii) an issuer of the token, which, for example, can be the first access control system (e.g., 106A), etc.

Once the authenticity of security token 212 has been verified, the first privileges of security token 212 may be ingested. The first access control system (e.g., 106A) may check that the first privileges include the function call for the acquisition of the second resource. Because the second resource may be acquired from the second software, the first privileges, which are generated by the first software, may not be used in determining whether the user has sufficient privileges to acquire the second resource.

As a result, at interaction 220, the first access control system (e.g., 106A) may send security token 212 to access control management system 104. Access control management system 104 may receive security token 212 and perform access control management token generation process 222.

During access control management token generation process 222, the first privileges may be extracted from security token 212. Using the first privileges, access control management system 104 may rewrite the first privileges in terms of second privileges that apply to a policy used by the second software.

Access control management system 104 may rewrite the first privileges by (i) obtaining, from a mapping repository, related definitions of definitions that relate the first privileges of the first software to the second privileges of the second software, (ii) using the related definitions to recast a role of the user, from security token 212, in terms of the second privileges to generate rewritten privileges, and (iii) generating, using the rewritten privileges, a management token that comprises the role of the user.

The management token may be generated by (i) generating an encoded data structure, such as a digital certificate, JavaScript Object Notation (JSON) object, etc., and (ii) writing the rewritten privileges on the encoded data structure. The mapping repository may include the definitions for the first privileges for the first software, the definitions of the second privileges for the second software, and the definitions that associate the first privileges with the second privileges and that are used to derive the second privileges from the first privileges during generation of the management token.

Access control management security token 224 may be the management token and may be generated during access control management token generation process 222. Access control management security token 224 may include the rewritten privileges, which include the first privileges in terms of the second privileges. Having the first privileges in terms of the second privileges may confirm sufficient privileges for a performance of an operation on the second script by the user.

To permit the user to make the second request with access control management security token 224, access control management security token 224 may be provided by access control management system 104 to the data processing system (e.g., 100A) to the user.

Thus, via the interaction illustrated in FIG. 2C, a system in accordance with an embodiment may generate the access control management security token. Consequently, a deployment (e.g., 100) may be more likely to be able to provide desired computer implemented services by providing the access control management security token that can be ingested and read by the first access control system (e.g., 106A) for the first software to acquire the second resource from the second software.

Turning to FIG. 2D, a fourth interaction diagram in accordance with an embodiment is shown. The fourth interaction diagram may illustrate data used in and data processing performed in acquiring a second resource from a second software.

To acquire the second resource from a second software, second software resource request process 226 may be performed. During second software resource request process 226, the user may make a second request using the first software and access control management security token 224. The user may make the second request by, for example, generating a second source code in a second script which includes a second function call for acquisition of second resource and also includes access control management security token 224 in the second script. The second resource may be acquired from a second software. The script may be passed to the access control management system 104.

Access control management system 104 may receive the script. Upon receiving the script, access control management system 104 may extract the function call for the acquisition of the second resource and access control management security token 224. Access control management system 104 may verify the authenticity of the token by verifying (i) a signature of access control management security token 224 to ensure the signature has not been modified, (ii) an expiration date and/or time on access control management security token 224 to ensure the data and/or the time have not passed, (iii) an issuer, having been access control management system 104, of access control management security token 224.

Once the authenticity of access control management security token 224 has been verified, the privileges of access control management security token 224 may be ingested. The privileges may be rewritten privileges that include the first privileges in terms of the second privileges. The rewritten privileges may have been written by access control management system 104 and therefore may be confirmed to be sufficient privileges for a performance of an operation written in the second script by the user.

As a result, the script may be passed from access control management system 104 to the second data processing system (e.g., 100B). The second processing system may receive the script and perform the function call written in the script. The function call written in the script may perform (i) a read of second software resource 228 and (ii) acquire second software resource 228. Second software resource 228 may be acquired by transferring second software resource 228 to the first data processing system (e.g. 100A) from the second data processing system (e.g., 100B). Second software resource 228 may include data stored in files, folders that include files, database records, software, etc.

Thus, via the interaction illustrated in FIG. 2D, a system in accordance with an embodiment may acquire the second resource from the second software. Consequently, a deployment (e.g., 100) may be more likely to be able to provide desired computer implemented services by using the access control management security token to acquire the second resource from the second software.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a deployment in accordance with an embodiment is shown. The method may be performed, for example, by any of the components of the system of FIG. 1, and/or other components not shown therein.

At operation 300, a token may be obtained, by an access control management system and from a first access control system, the token issued by the first access control system for a user of first software associated with the first access control system and a request for use of second software. The token may be obtained by receiving, by the access control management, the token, upon which the access control management system may extract first privileges for a first software from the token.

At operation 302, a management token may be generated by the access control management system and may be based on the token and a mapping repository. The management token may be generated by (i) obtaining, from the mapping repository, related definitions of the definitions that relate the first privileges of the first software to the second privileges of the second software, (ii) using the related definitions to recast the role of the user, from the token, in terms of the second privileges to generate rewritten privileges; and (iii) generating, using the rewritten privileges, a management token that comprises the role of the user, the management token storing the rewritten privileges.

The related definitions may be obtained by performing a lookup of the mapping repository. The lookup may search for (i) terms that are shared by the first privileges and the second privileges, (ii) the related definitions including the first privileges written in terms of the second privileges, (iii) the related definitions including the second privileges written in the terms of the first privileges, etc. The related definitions may be used by replacing the first privileges, extracted from the token, with the related definitions that are written in the terms of the second privileges to generate rewritten privileges. A management token may be generated by (i) generating an encoded data structure, such as a digital certificate, JavaScript Object Notation (JSON) object, etc., and (ii) writing the rewritten privileges on the encoded data structure.

At operation 304, the management token may be provided by the access control management system to the first access control system to enable the user to use second software without requiring a second access control system for the second software to be queried for privilege of the user. The management token may be provided by the access control management system by transferring the management token from the access control management system to the first software for the user.

The method may end following operation 304.

Thus, via the method shown in FIG. 3, embodiments herein may likely improve a likelihood of managing the operation of the deployment. By improving the likelihood of managing the operation of the deployment, the data processing systems may be more likely to provide desirable computer implemented services by, for example, recasting first privileges of a first software in terms of second privileges of a second software to generate rewritten privileges, using the rewritten privileges, on a management token, to acquire a resource from a second software by a user using a first software, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment, the method comprising:
obtaining, by an access control management system and from a first access control system, a token issued by the first access control system for a user of first software associated with the first access control system and a request for use of second software;
generating, by the access control management system, a management token based on the token and a mapping repository; and
providing, by the access control management system, the management token to the first access control system to enable the user to use second software without requiring a second access control system for the second software to be queried for privilege of the user.

2. The method of claim 1, further comprising:
before obtaining the token issued by the first access control system:
identifying the first software and the first access control system of the first software in the deployment;
identifying the second software and the second access control system of the second software in the deployment;
installing the access control management system in the deployment to serve as a central access control hub for the first access control system and for the second access control system;
configuring the access control management system with the mapping repository to translate first privileges for the first software from the token issued by the first access control system into second privileges for the second software; and
generating a trust network by establishing a secure communication protocol between the access control management system, the first access control system and the second access control system.

3. The method of claim 1, wherein the first access control system grants access to a user, based on first privileges of a role assigned to the user, to obtain data from the first software.

4. The method of claim 3, wherein the token stores the first privileges of the role assigned to the user and is used to authenticate an identity of the user by the first access control system.

5. The method of claim 4, wherein the management token stores the first privileges written in terms of second privileges the second software.

6. The method of claim 5, wherein the mapping repository comprises definitions for the first privileges for the first software, the definitions of the second privileges for the second software, and the definitions that associate the first privileges with the second privileges and that are used to derive the second privileges from the first privileges during generation of the management token.

7. The method of claim 6, wherein generating, by the access control management system, the management token comprises:
obtaining, from the mapping repository, related definitions of the definitions that relate the first privileges of the first software to the second privileges of the second software;
using the related definitions to recast the role of the user, from the token, in terms of the second privileges to generate rewritten privileges; and
generating, using the rewritten privileges, a management token that comprises the role of the user, the management token indicating the rewritten privileges.

8. The method of claim 1, further comprising:
obtaining, from the first access control system, a request for the management token and the token;
logging, by the access control management system, the request for the management token;
generating the management token when the token is valid and the request is verified; and
invalidating the token when malicious activity is detected in the request.

9. A non-transitory machine-readable medium having instructions stored therein, which when executed by a processor, cause the processor to perform operations for managing operation of a deployment, the operations comprising:
obtaining, by an access control management system and from a first access control system, a token issued by the first access control system for a user of first software associated with the first access control system and a request for use of second software;
generating, by the access control management system, a management token based on the token and a mapping repository; and
providing, by the access control management system, the management token to the first access control system to enable the user to use second software without requiring a second access control system for the second software to be queried for privilege of the user.

10. The non-transitory machine-readable medium of claim 9, wherein the operations further comprise:
before obtaining the token issued by the first access control system:
identifying the first software and the first access control system of the first software in the deployment;
identifying the second software and the second access control system of the second software in the deployment;
installing the access control management system in the deployment to serve as a central access control hub for the first access control system and for the second access control system;
configuring the access control management system with the mapping repository to translate first privileges for the first software from the token issued by the first access control system into second privileges for the second software; and
generating a trust network by establishing a secure communication protocol between the access control management system, the first access control system and the second access control system.

11. The non-transitory machine-readable medium of claim 9, wherein the first access control system grants access to a user, based on first privileges of a role assigned to the user, to obtain data from the first software.

12. The non-transitory machine-readable medium of claim 11, wherein the token stores the first privileges of the role assigned to the user and is used to authenticate an identity of the user by the first access control system.

13. The non-transitory machine-readable medium of claim 12, wherein the management token stores the first privileges written in terms of second privileges the second software.

14. The non-transitory machine-readable medium of claim 13, wherein the mapping repository comprises definitions for the first privileges for the first software, the definitions of the second privileges for the second software, and the definitions that associate the first privileges with the second privileges and that are used to derive the second privileges from the first privileges during generation of the management token.

15. A data processing system, comprising:
a processor; and
a memory coupled to the processor to store instructions, which when executed by the processor, cause the processor to perform operations managing operation of a
deployment, the operations comprising:
obtaining, by an access control management system and from a first access control system, a token issued by the first access control system for a user of first software associated with the first access control system and a request for use of second software;
generating, by the access control management system, a management token based on the token and a mapping repository; and
providing, by the access control management system, the management token to the first access control system to enable the user to use second software without requiring a second access control system for the second software to be queried for privilege of the user.

16. The data processing system of claim 15, wherein the operations further comprise:
before obtaining the token issued by the first access control system:
identifying the first software and the first access control system of the first software in the deployment;
identifying the second software and the second access control system of the second software in the deployment;
installing the access control management system in the deployment to serve as a central access control hub for the first access control system and for the second access control system;
configuring the access control management system with the mapping repository to translate first privileges for the first software from the token issued by the first access control system into second privileges for the second software; and
generating a trust network by establishing a secure communication protocol between the access control management system, the first access control system and the second access control system.

17. The data processing system of claim 15, wherein the first access control system grants access to a user, based on first privileges of a role assigned to the user, to obtain data from the first software.

18. The data processing system of claim 17, wherein the token stores the first privileges of the role assigned to the user and is used to authenticate an identity of the user by the first access control system.

19. The data processing system of claim 18, wherein the management token stores the first privileges written in terms of second privileges the second software.

20. The data processing system of claim 19, wherein the mapping repository comprises definitions for the first privileges for the first software, the definitions of the second privileges for the second software, and the definitions that associate the first privileges with the second privileges and that are used to derive the second privileges from the first privileges during generation of the management token.
